(19) United States
(12) Patent Application Publication
(10) Pub. No.: US 2023/0071176 A1
(43) Pub. Date: Mar. 9, 2023

(54) WATERPROOF BUTTON ASSEMBLY

(71) Applicant: Cheng Uei Precision Industry Co., LTD., New Taipei City (TW)

(72) Inventor: YI-PING LIAO, New Taipei City (TW)

(21) Appl. No.: 17/855,781

(22) Filed: Jun. 30, 2022

(30) Foreign Application Priority Data
Sep. 7, 2021 (CN) 202122155394.6

(51) Int. Cl. H01H 13/06; H01H 13/14; H01H 13/86

(52) U.S. Cl. CPC H01H 13/06; H01H 13/14; H01H 13/86; H01H 2223/002

(57) ABSTRACT

A waterproof button assembly includes a body, an elastic element, a first sealing element, a second sealing element, a lower cover, a circuit board and an upper cover. The body is recessed downward to form an upper accommodating groove. The body is recessed inward to form a lower accommodating groove. A bottom wall of the upper accommodating groove is recessed downward to form a holding groove. The bottom wall of the upper accommodating groove defines a first through hole. The body has an opening. The elastic element is mounted in the holding groove. The first sealing element is mounted around the first through hole. The second sealing element is assembled to the opening. The lower cover covers the lower accommodating groove to form an assembling space. The circuit board is assembled in the assembling space. The upper cover is assembled in the upper accommodating groove.

### CROSS REFERENCE TO RELATED APPLICATION

The present application is based on, and claims priority from, China Patent Application No. 202122155394.6, filed Sep. 7, 2021, the disclosure of which is hereby incorporated by reference herein in its entirety.

### BACKGROUND OF THE INVENTION

### 1. Field of the Invention

The present invention generally relates to a button assembly, and more particularly to a waterproof button assembly capable of keeping an assembling space dry and assembling electronic components in the assembling space.

### 2. The Related Art

With the popularity of sports, more and more people will participate in activities of two wheel vehicles, such as motorcycle activities, bicycle activities or scooter activities. Therefore, the two wheel vehicles need be equipped with more new functions to improve a convenience and a safety of riding each two wheel vehicle.

In order to make the two wheel vehicles have the new functions, various electronic products which include circuit boards with different functions must be mounted to the two wheel vehicles. In order to improve the convenience of riding each two wheel vehicle, each two wheel vehicle needs to have a mechanical structure which is light and simple, for example, a button is conveniently pressed by a user to activate different functions at the time of riding the two wheel vehicle.

However, in case of rainy weather, water will enter the mechanical structure, so short circuit phenomena of electronic components and circuit boards are caused, and the electronic components and the circuit boards are damaged.

Thus, it is necessary to provide a waterproof button assembly that is capable of keeping an assembling space dry and assembling electronic components in the assembling space.

### SUMMARY OF THE INVENTION

An object of the present invention is to provide a waterproof button assembly. The waterproof button assembly includes a body, an elastic element, a first sealing element, a second sealing element, a lower cover, a circuit board and an upper cover. An upper surface of the body is recessed downward to form an upper accommodating groove. A lower surface of the body is recessed inward to form a lower accommodating groove. A bottom wall of the upper accommodating groove is recessed downward to form a holding groove. The bottom wall of the upper accommodating groove defines a first through hole penetrating through the bottom wall of the upper accommodating groove along an up-down direction. The first through hole is communicated with a bottom of the holding groove. The holding groove is positioned around a periphery of a top mouth of the first through hole. The body has an opening penetrating through the body along the up-down direction. The opening is communicated between the upper accommodating groove and the lower accommodating groove. The elastic element is mounted in the holding groove. The first sealing element is mounted around a periphery of a bottom mouth of the first through hole. The second sealing element is assembled to a top of the opening of the body. The lower cover covers the lower accommodating groove to form an assembling space between the lower cover and the body. One side of the lower cover defines a second through hole penetrating through the one side of the lower cover along the up-down direction. The second through hole is disposed corresponding to the first through hole. A part of an upper surface of the lower cover abuts against a lower surface of the first sealing element. The assembling space is sealed by the first sealing element and the second sealing element. The circuit board is assembled in the assembling space. The circuit board is equipped with a key. The key is disposed corresponding to the second sealing element. The upper cover is assembled in the upper accommodating groove. A lower surface of the upper cover protrudes downward to form a pressing portion. The pressing portion abuts against an upper surface of the second sealing element. The lower surface of the upper cover protrudes downward to form an extending portion. The extending portion is disposed corresponding to the first through hole. The extending portion passes downward through the elastic element, the holding groove, the first through hole, a middle of the first sealing element and the second through hole from the upper accommodating groove.

Another object of the present invention is to provide a waterproof button assembly. The waterproof button assembly includes a body, a plurality of elastic elements, a plurality of first sealing elements, a plurality of second sealing elements, a lower cover, a circuit board and a plurality of upper covers. Several portions of an upper surface of the body are recessed downward to form a plurality of upper accommodating grooves. A lower surface of the body is recessed inward to form a lower accommodating groove. Two sides of a bottom wall of each upper accommodating groove are recessed downward to form two holding grooves. A bottom wall of each holding groove defines a first through hole penetrating through the bottom wall of each holding groove along an up-down direction. Each holding groove is positioned around a periphery of a top mouth of the first through hole of each holding groove. Several portions of the lower surface of the body are recessed inward to form a plurality of first sealing slots. Each first sealing slot is disposed around a periphery of a bottom mouth of the first through hole of one holding groove. A middle of the bottom wall of each upper accommodating groove is recessed downward to form a second sealing slot. The second sealing slot is located between the two holding grooves. The body has a plurality of openings penetrating through the body along the up-down direction. Each opening penetrates through a bottom wall of one second sealing slot along the up-down direction. The opening is communicated between the upper accommodating groove and the lower accommodating groove. The plurality of the elastic elements are mounted in the holding grooves of the body. The plurality of the first sealing elements are sealed in the first sealing slots of the body. Each second sealing element is sealed in the one second sealing slot of the body. Each second sealing element is assembled to a top of one opening. The lower cover covers the lower accommodating groove to form an assembling space between the lower cover and the body. The lower cover defines a plurality of second through holes vertically penetrating through the lower cover. Each second through hole is disposed corresponding to the first through hole of the one holding groove. Each first sealing slot is disposed around one second through hole. An upper surface of the lower cover abuts against a lower surface of each first sealing element. The assembling space is sealed by each first sealing element and each second sealing element. The circuit board is assembled in the assembling space. The circuit board is equipped with a plurality of keys. Each key is disposed corresponding to one second sealing element. The plurality of the upper covers are assembled in the plurality of the upper accommodating grooves. A middle of a lower surface of each upper cover protrudes downward to form a pressing portion. The pressing portion of each upper cover abuts against an upper surface of the one second sealing element. Two sides of the lower surface of each upper cover protrude downward to form two extending portions. Each extending portion is disposed corresponding to the first through hole of the one holding groove. Each extending portion passes downward through one elastic element, the one holding groove, the first through hole of the one holding groove, one first sealing slot, a middle of one first sealing element and the one second through hole from one upper accommodating groove.

Another object of the present invention is to provide a waterproof button assembly. The waterproof button assembly includes a body, a plurality of elastic elements, a plurality of first sealing elements, a plurality of second sealing elements, a lower cover, a circuit board, a plurality of upper covers and a plurality of fixing elements. Several portions of an upper surface of the body are recessed downward to form a plurality of upper accommodating grooves. A lower surface of the body is recessed inward to form a lower accommodating groove. Two sides of a bottom wall of each upper accommodating groove are recessed downward to form two holding grooves. A bottom wall of each holding groove defines a first through hole penetrating through the bottom wall of each holding groove along an up-down direction. Each holding groove is positioned around a periphery of a top mouth of the first through hole of each holding groove. Several portions of the lower surface of the body are recessed inward to form a plurality of first sealing slots. Each first sealing slot is disposed around a periphery of a bottom mouth of one first through hole. A middle of the bottom wall of each upper accommodating groove is recessed downward to form a second sealing slot. The second sealing slot of each upper accommodating groove is located between the two holding grooves of each upper accommodating groove. The body has a plurality of openings. Each opening penetrates through a bottom wall of the second sealing slot of one upper accommodating groove along the up-down direction. Each opening is communicated between the one upper accommodating groove and the lower accommodating groove. The plurality of the elastic elements are mounted in the holding grooves of the body. The plurality of the first sealing elements are sealed in the first sealing slots of the body. Each second sealing element seals the second sealing slot of the one upper accommodating groove of the body. Each second sealing element is assembled to a top of one opening. The lower cover covers the lower accommodating groove to form an assembling space between the lower cover and the body. The lower cover has a base portion. Several portions of an upper surface of the base portion protrude upward to form a plurality of convex portions. The lower cover defines a plurality of second through holes vertically penetrating through the base portion and middles of the plurality of the convex portions. Each second through hole is disposed corresponding to the first through hole of the one holding groove. Each first sealing slot is disposed around one second through hole. An upper surface of each convex portion abuts against a lower surface of one first sealing element. Each first sealing element seals between one first sealing slot and one convex portion. The assembling space is sealed by each first sealing element and each second sealing element. The circuit board is assembled in the assembling space. The circuit board is equipped with a plurality of keys. Each key is disposed corresponding to one second sealing element. The plurality of the upper covers are assembled in the plurality of the upper accommodating grooves. A middle of a lower surface of each upper cover protrudes downward to form a pressing portion. The pressing portion of each upper cover abuts against an upper surface of the one second sealing element. Two sides of the lower surface of each upper cover protrude downward to form two extending portions. Each extending portion is disposed corresponding to the first through hole of the one holding groove. Each extending portion passes downward through one elastic element, the one holding groove, the first through hole of the one holding groove, the one first sealing slot, a middle of the one first sealing element and the one second through hole from one upper accommodating groove. The plurality of the fixing elements are connected to bottoms of the extending portions of the plurality of the upper covers. A middle of a bottom surface of each extending portion is recessed inward to form a fixing hole. Each fixing element is fixed in the fixing hole of one extending portion. An outer edge of a free end of each fixing element protrudes outward to form an abutting portion. The abutting portion of each fixing element abuts against a bottom of a peripheral wall of the one second through hole.

As described above, the waterproof button assembly seals the assembling space by the first sealing element and the second sealing element, so that water is unable to enter the assembling space. As a result, the waterproof button assembly is capable of keeping the assembling space dry and assembling the circuit board in the assembling space for a normal use.

### BRIEF DESCRIPTION OF THE DRAWINGS

The present invention will be apparent to those skilled in the art by reading the following description, with reference to the attached drawings, in which:

FIG. 1 is a perspective view of a waterproof button assembly in accordance with a preferred embodiment of the present invention;

FIG. 2 is an exploded view of the waterproof button assembly in accordance with the preferred embodiment of the present invention;

FIG. 3 is another exploded view of the waterproof button assembly in accordance with the preferred embodiment of the present invention;

FIG. 4 is a cross-section view of the waterproof button assembly along a line IV-IV of FIG. 1, wherein the waterproof button assembly is without being pressed;

FIG. 5 is a cross-section view of the waterproof button assembly along a line V-V of FIG. 1, wherein the waterproof button assembly is pressed; and

FIG. 6 is an enlarged view of an encircled portion VI of the waterproof button assembly of FIG. 5.

### DETAILED DESCRIPTION OF THE PREFERRED EMBODIMENT

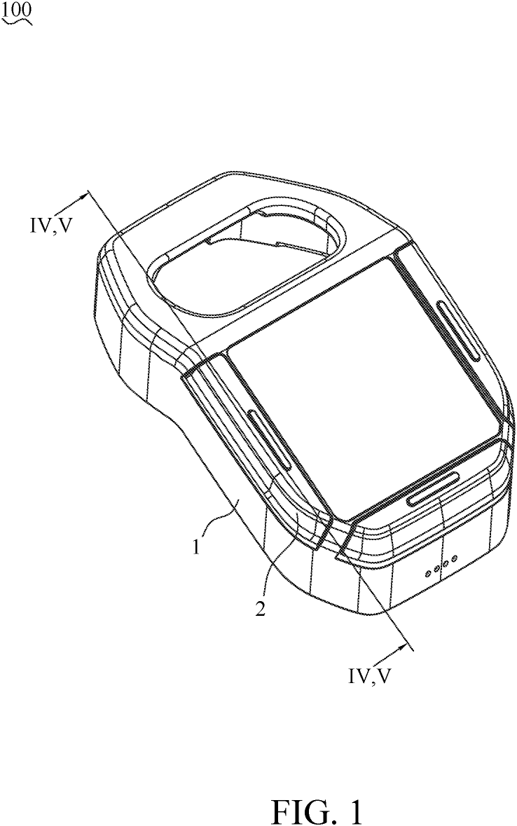

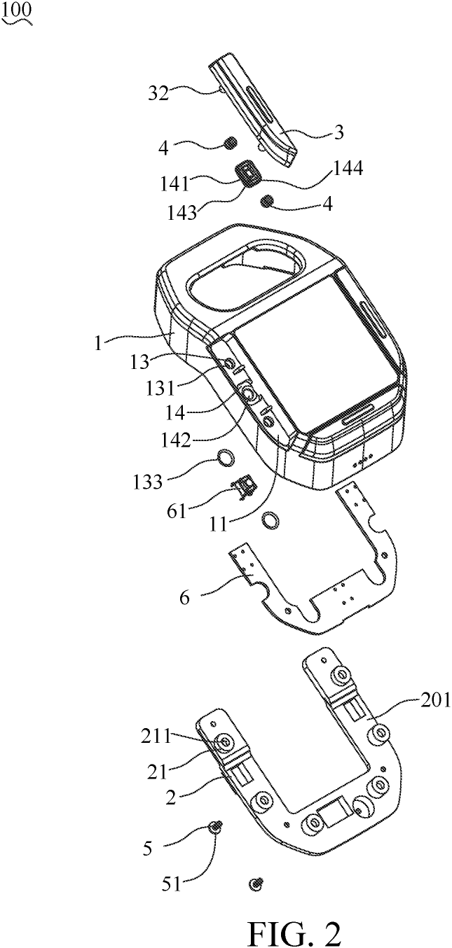

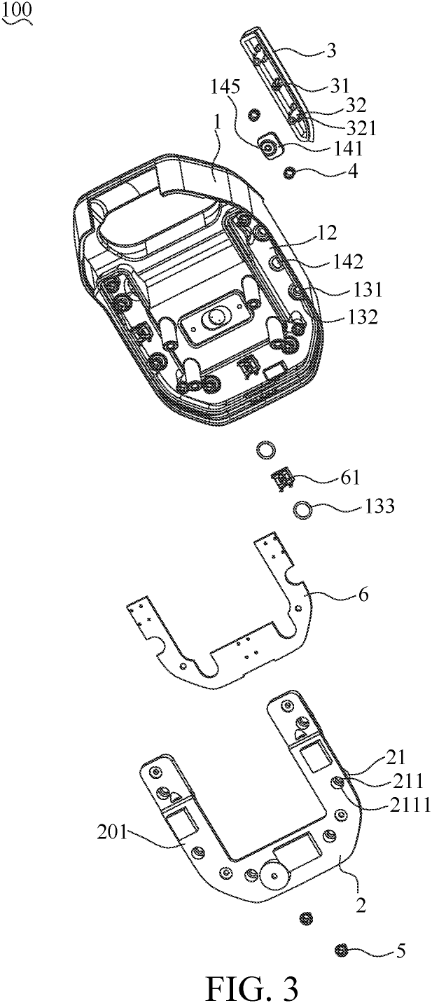

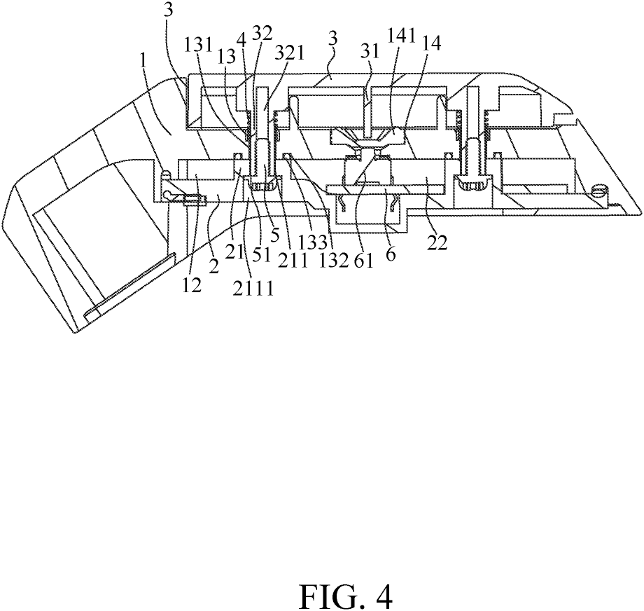

With reference to FIG. 1 to FIG. 4, a waterproof button assembly 100 in accordance with a preferred embodiment of the present invention is shown. The waterproof button assembly 100 includes a body 1, a lower cover 2, an upper cover 3, an elastic element 4, a fixing element 5 and a circuit board 6. In the preferred embodiment, the waterproof button assembly 100 includes the body 1, the lower cover 2, a plurality of the upper covers 3, a plurality of the elastic elements 4, a plurality of the fixing elements 5 and the circuit board 6.

An upper surface of the body 1 is recessed downward to form an upper accommodating groove 11. A lower surface of the body 1 is recessed inward to form a lower accommodating groove 12. The lower accommodating groove 12 is located under the upper accommodating groove 11. A portion of a bottom wall of the upper accommodating groove 11 is recessed downward to form a holding groove 13. The elastic element 4 is accommodated in the upper accommodating groove 11. The elastic element 4 is mounted in the holding groove 13. The bottom wall of the upper accommodating groove 11 defines a first through hole 131 penetrating through the bottom wall of the upper accommodating groove 11 along an up-down direction. A bottom wall of the holding groove 13 defines the first through hole 131 penetrating through the bottom wall of the holding groove 13 along the up-down direction. The first through hole 131 is communicated with a bottom of the holding groove 13. A portion of the lower surface of the body 1 is recessed inward to form a first sealing slot 132 around a periphery of a bottom mouth of the first through hole 131. The holding groove 13 is positioned around a periphery of a top mouth of the first through hole 131.

The waterproof button assembly 100 includes a first sealing element 133 and a second sealing element 141. The first sealing element 133 is sealed in the first sealing slot 132. The first sealing element 133 is mounted around the periphery of the bottom mouth of the first through hole 131. Another portion of the bottom wall of the upper accommodating groove 11 is recessed downward to form a second sealing slot 14. The body 1 has an opening 142 penetrating through the body 1 along the up-down direction. The opening 142 penetrates through a bottom wall of the second sealing slot 14 along the up-down direction. The opening 142 is communicated between the upper accommodating groove 11 and the lower accommodating groove 12. The second sealing slot 14 is communicated with the opening 142. The second sealing slot 14 is positioned around a periphery of a top mouth of the opening 142. The second sealing element 141 is assembled to the second sealing slot 14. The second sealing element 141 is sealed in the second sealing slot 14. The second sealing element 141 is assembled to a top of the opening 142 of the body 1. The second sealing element 141 has a thin middle portion 143 and a thick peripheral portion 144. A middle of a bottom surface of the second sealing element 141 protrudes downward to form a protrusion 145.

In the preferred embodiment, the elastic element 4 is a spring. The first sealing slot 132 is an annular shape, and the first sealing element 133 is the annular shape. Each of the first sealing element 133 and the second sealing element 141 is made of a silicone material.

In the preferred embodiment, the waterproof button assembly 100 includes three upper covers 3. Several portions of the upper surface of the body 1 are recessed downward to form a plurality of upper accommodating grooves 11. A front and two sides of the upper surface of the body 1 are recessed downward to form three upper accommodating grooves 11. A front and two sides of the lower surface of the body 1 are recessed inward to together form the lower accommodating groove 12. The lower accommodating groove 12 is a U shape seen from a bottom view. The lower accommodating groove 12 is located under the upper accommodating grooves 11 of the body 1. Two sides of the bottom wall of each upper accommodating groove 11 are recessed downward to form two holding grooves 13. The plurality of the elastic elements 4 are accommodated in the plurality of the upper accommodating grooves 11. The plurality of the elastic elements 4 are mounted in the holding grooves 13 of the body 1. The bottom wall of each holding groove 13 defines the first through hole 131 penetrating through the bottom wall of each holding groove 13 along the up-down direction. Each holding groove 13 is positioned around the periphery of the top mouth of the first through hole 131. The holding grooves 13 of the body 1 are communicated with the first through holes 131 of the body 1. Several portions of the lower surface of the body 1 are recessed inward to form a plurality of the first sealing slots 132. Each first sealing slot 132 is disposed around the periphery of the bottom mouth of the first through hole 131 of one holding groove 13. The body 1 has six holding grooves 13, six first through holes 131 and six first sealing slots 132.

In the preferred embodiment, the waterproof button assembly 100 includes a plurality of the first sealing elements 133 and a plurality of the second sealing elements 141. Each first sealing slot 132 is the annular shape, and each first sealing element 133 is the annular shape. Each first sealing element 133 and each second sealing element 141 are made of the silicone materials. The plurality of the first sealing elements 133 are sealed in the first sealing slots 132 of the body 1. A middle of the bottom wall of each upper accommodating groove 11 is recessed downward to form the second sealing slot 14. The second sealing slot 14 of each upper accommodating groove 11 is located between the two holding grooves 13 of each upper accommodating groove 11. The body 1 has a plurality of the openings 142 penetrating through the body 1 along the up-down direction. Each opening 142 penetrates through the bottom wall of the second sealing slot 14 of one upper accommodating groove 11 along the up-down direction. Each opening 142 is communicated between the one upper accommodating groove 11 and the lower accommodating groove 12. The second sealing slots 14 of the body 1 are communicated with the openings 142 of the body 1. Each second sealing element 141 is assembled to one second sealing slot 14 of the body 1. Each second sealing element 141 is sealed in the second sealing slot 14 of the one upper accommodating groove 11 of the body 1. Each second sealing element 141 is assembled to the top of one opening 142. The waterproof button assembly 100 includes six first sealing elements 133, three second sealing slots 14, three second sealing elements 141 and three openings 142.

The lower cover 2 is the U shape seen from a vertical view. The lower cover 2 has a base portion 201. The base portion 201 is the U shape seen from the vertical view. An upper surface of the base portion 201 of the lower cover 2 protrudes upward to form a convex portion 21. The convex portion 21 is a cylinder shape. One side of the lower cover 2 defines a second through hole 211 penetrating through the one side of the lower cover along the up-down direction. The second through hole 211 penetrates through the base portion 201 and a middle of the convex portion 21 of the lower cover 2 along the up-down direction. The second through hole 211 is disposed corresponding to the first through hole 131. The first sealing slot 132 is disposed around the second through hole 211. A part of an upper surface of the lower cover 2 abuts against a lower surface of the first sealing element 133. An upper surface of the convex portion 21 abuts against the lower surface of the first sealing element 133. A bottom of the second through hole 211 expands outward to form an expanding hole 2111. A diameter of the expanding hole 2111 is larger than a diameter of the second through hole 211. The waterproof button assembly 100 has an assembling space 22. The lower cover 2 covers the lower accommodating groove 12 to form the assembling space 22 between the lower cover 2 and the body 1. The assembling space 22 of the waterproof button assembly 100 is sealed by the first sealing element 133 and the second sealing element 141. The circuit board 6 is the U shape. The assembling space 22 is the U shape. The circuit board 6 is assembled in the assembling space 22. The circuit board 6 is equipped with a key 61. The key 61 is disposed corresponding to the second sealing element 141. The key 61 is disposed corresponding to the protrusion 145 of the second sealing element 141.

In the preferred embodiment, several portions of the upper surface of the base portion 201 of the lower cover 2 protrude upward to form a plurality of the convex portions 21. Each convex portion 21 is the cylinder shape. The lower cover 2 defines a plurality of the second through holes 211 vertically penetrating through the base portion 201 and the middles of the plurality of the convex portions 21 of the lower cover 2. Each second through hole 211 is disposed corresponding to the first through hole 131 of the one holding groove 13. Each first sealing slot 132 is disposed around one second through hole 211. The upper surface of the lower cover 2 abuts against the lower surface of each first sealing element 133. The upper surface of each convex portion 21 abuts against the lower surface of one first sealing element 133. The assembling space 22 is sealed by each first sealing element 133 and each second sealing element 141. The bottom of each second through hole 211 expands outward to form the expanding hole 2111. The diameter of the expanding hole 2111 is larger than the diameter of each second through hole 211. The circuit board 6 is equipped with a plurality of the keys 61. The circuit board 6 is equipped with three keys 61. Each key 61 is disposed corresponding to one second sealing element 141. The lower cover 2 has six convex portions 21, six second through holes 211 and six expanding holes 2111.

The upper cover 3 is assembled in the upper accommodating groove 11. A lower surface of the upper cover 3 protrudes downward to form a pressing portion 31. The pressing portion 31 abuts against an upper surface of the second sealing element 141 to enhance a waterproof sealing effect of the second sealing element 141. The lower surface of the upper cover 3 protrudes downward to form an extending portion 32. The extending portion 32 is disposed corresponding to the first through hole 131. The extending portion 32 passes downward through the elastic element 4, the holding groove 13, the first through hole 131, the first sealing slot 132, a middle of the first sealing element 133 and the second through hole 211 from the upper accommodating groove 11.

A middle of a bottom surface of the extending portion 32 is recessed inward to form a fixing hole 321. The fixing element 5 is fixed in the fixing hole 321. An outer edge of a free end of the fixing element 5 protrudes outward to form an abutting portion 51. The abutting portion 51 is located in the expanding hole 2111. The elastic element 4 is mounted around the extending portion 32. An elastic force of the elastic element 4 is exerted upward to the lower surface of the upper cover 3, so the extending portion 32 is pushed upward by the elastic element 4, the abutting portion 51 of the fixing element 5 abuts against a bottom of a periphery wall of the second through hole 211, and simultaneously, the elastic force of the elastic element 4 which is exerted to the upper cover 3 is balanced for maintaining a position of the upper cover 3 in the upper accommodating groove 11. In the preferred embodiment, the fixing element 5 is a screw, and the abutting portion 51 is a washer of the screw.

In the preferred embodiment, the plurality of the upper covers 3 are assembled in the plurality of the upper accommodating grooves 11. The three upper covers 3 are assembled in the three upper accommodating grooves 11. A middle of the lower surface of each upper cover 3 protrudes downward to form the pressing portion 31. The pressing portion 31 of each upper cover 3 abuts against the upper surface of the one second sealing element 141 to enhance the waterproof sealing effect of the one second sealing element 141. Two sides of the lower surface of each upper cover 3 protrude downward to form two extending portions 32. Each extending portion 32 is disposed corresponding to the first through hole 131 of the one holding groove 13. Each extending portion 32 passes downward through one elastic element 4, the one holding groove 13, the first through hole 131 of the one holding groove 13, one first sealing slot 132, the middle of the one first sealing element 133 and the one second through hole 211 from one upper accommodating groove 11. The three upper covers 3 include a plurality of the pressing portions 31 and a plurality of the extending portions 32. The three upper covers 3 include three pressing portions 31 and six extending portions 32.

In the preferred embodiment, the middle of the bottom surface of each extending portion 32 is recessed inward to form the fixing hole 321. Each fixing element 5 is fixed in the fixing hole 321 of one extending portion 32. The outer edge of the free end of each fixing element 5 protrudes outward to form the abutting portion 51. The abutting portion 51 of each fixing element 5 is located in the expanding hole 2111. The plurality of the elastic elements 4 are accommodated in the plurality of the upper accommodating grooves 11. Each elastic element 4 is mounted around the one extending portion 32. The elastic force of each elastic element 4 is exerted upward to the lower surface of one upper cover 3, so each extending portion 32 is pushed upward by the one elastic element 4, the abutting portion 51 of each fixing element 5 abuts against the bottom of the periphery wall of the one second through hole 211, and simultaneously, the elastic force of each elastic element 4 which is exerted to the one upper cover 3 is balanced for maintaining the position of each upper cover 3 in the one upper accommodating groove 11. Each fixing element 5 is the screw, and the abutting portion 51 of each fixing element 5 is the washer of the screw. The plurality of the fixing elements 5 are connected to bottoms of the extending portions 32 of the plurality of the upper covers 3. The lower cover 2 is fastened to the body 1 by the plurality of the fixing elements 5, and then the assembling space 22 becomes a sealed status.

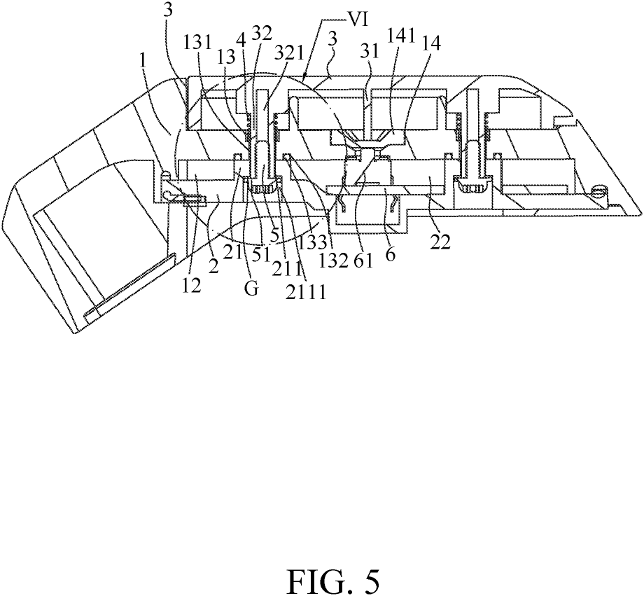

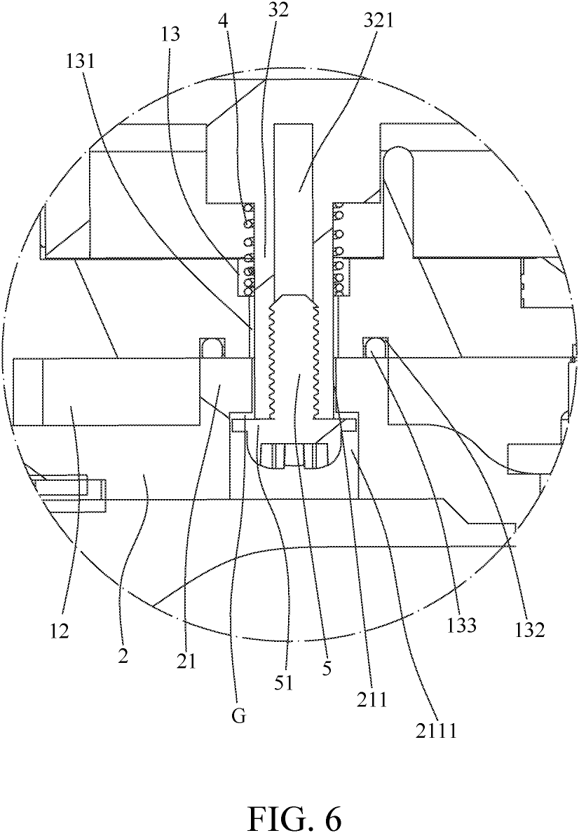

With reference to FIG. 1 to FIG. 6, when water splashes on the waterproof button assembly 100, the waterproof button assembly 100 encounters the water or the waterproof button assembly 100 is immersed in the water, and the water flows between the upper cover 3 and the upper accommodating groove 11, the second sealing element 141 seals the second sealing slot 14, and the first sealing element 133 seals between the first sealing slot 132 and the convex portion 21, so that the sealed status of the assembling space 22 is maintained. Therefore, the water is unable to enter the assembling space 22, so that the circuit board 6 is prevented from being damaged on account of touching the water. If the water enters between the upper cover 3 and the upper accommodating groove 11, the water enters the second through hole 211 along the holding groove 13, the abutting portion 51 of the fixing element 5 abuts against the bottom of the periphery wall of the second through hole 211, the water is blocked by the abutting portion 51 and the water is accumulated in the second through hole 211.

With reference to FIG. 1 to FIG. 6, in the preferred embodiment, when the water splashes on the waterproof button assembly 100, the waterproof button assembly 100 encounters the water or the waterproof button assembly 100 is immersed in the water, and the water flows between each upper cover 3 and the upper accommodating groove 11, each second sealing element 141 seals the one second sealing slot 14, and each first sealing element 133 seals between the one first sealing slot 132 and one convex portion 21, so that the sealed status of the assembling space 22 is maintained. If the water enters between each upper cover 3 and the upper accommodating groove 11, the water enters the second through holes 211 of the lower cover 2 along the holding grooves 13 of the body 1, the abutting portion 51 of each fixing element 5 abuts against the bottom of the periphery wall of the one second through hole 211, the water is blocked by the abutting portion 51 and the water is accumulated in the one second through hole 211.

With reference to FIG. 1 to FIG. 6 again, when a user presses the waterproof button assembly 100, the user presses the upper cover 3, so that the pressing portion 31 pushes the thin middle portion 143 of the second sealing element 141 downward, at the same time, the thick peripheral portion 144 of the second sealing element 141 abuts against an inner wall of the second sealing slot 14 to seal the second sealing slot 14 more tightly, and the protrusion 145 of the second sealing element 141 presses the key 61 of the circuit board 6 downward, in this way, a function of the circuit board 6 is started. The extending portion 32 will move downward with the fixing element 5, so that the abutting portion 51 of the fixing element 5 moves downward, and the abutting portion 51 of the fixing element 5 leaves from the bottom of the periphery wall of the second through hole 211 to expose a gap G between the abutting portion 51 and the bottom of the periphery wall of the second through hole 211. The water accumulated in the second through hole 211 immediately flows downward out of the second through hole 211 through the gap G, so that the water accumulated between the upper cover 3 and the upper accommodating groove 11 is discharged outward. At the moment, the upper cover 3 is pressed downward on the elastic element 4, the elastic element 4 in the holding groove 13 is compressed by the upper cover 3, and the elastic element 4 accumulates a resilient force.

When the user releases the waterproof button assembly 100, the elastic force of the elastic element 4 pushes the upper cover 3 upward to an initial position. The pressing portion 31 and the extending portion 32 also return to the initial position, so that the pressing portion 31 finishes pressing the key 61, and the pressing portion 31 continues resisting against the second sealing element 141 to maintain the waterproof sealing effect. The abutting portion 51 of the fixing element 5 blocks the second through hole 211 again, the abutting portion 51 of the fixing element 5 is mounted to the extending portion 32, and the position of the upper cover 3 is restricted from leaving the upper accommodating groove 11 due to the elastic force of the elastic element 4. In this way, a pressing circulation of the waterproof button assembly 100 is completed.

When the user releases the waterproof button assembly 100, each pressing portion 31 and each extending portion 32 also return to the initial position, so that each pressing portion 31 finishes pressing one key 61, and each pressing portion 31 continues resisting against the one second sealing element 141 to maintain the waterproof sealing effect. The abutting portion 51 of each fixing element 5 blocks the one second through hole 211 again, the abutting portion 51 of each fixing element 5 is mounted to the one extending portion 32, and the position of each upper cover 3 is restricted from leaving the one upper accommodating groove 11 due to the elastic force of each elastic element 4.

As described above, the assembling space 22 of the waterproof button assembly 100 is sealed by the first sealing element 133 and the second sealing element 141, so that the water is unable to enter the assembling space 22. As a result, the waterproof button assembly 100 is capable of keeping the assembling space 22 dry and assembling the circuit board 6 in the assembling space 22 for a normal use.

What is claimed is:

1. A waterproof button assembly, comprising:
a body, an upper surface of the body being recessed downward to form an upper accommodating groove, a lower surface of the body being recessed inward to form a lower accommodating groove, a bottom wall of the upper accommodating groove being recessed downward to form a holding groove, the bottom wall of the upper accommodating groove defining a first through hole penetrating through the bottom wall of the upper accommodating groove along an up-down direction, the first through hole being communicated with a bottom of the holding groove, the holding groove being positioned around a periphery of a top mouth of the first through hole, the body having an opening penetrating through the body along the up-down direction, the opening being communicated between the upper accommodating groove and the lower accommodating groove;
an elastic element mounted in the holding groove;
a first sealing element mounted around a periphery of a bottom mouth of the first through hole;
a second sealing element assembled to a top of the opening of the body;
a lower cover covering the lower accommodating groove to form an assembling space between the lower cover and the body, one side of the lower cover defining a second through hole penetrating through the one side of the lower cover along the up-down direction, the second through hole being disposed corresponding to the first through hole, a part of an upper surface of the lower cover abutting against a lower surface of the first sealing element, the assembling space being sealed by the first sealing element and the second sealing element;
a circuit board assembled in the assembling space, the circuit board being equipped with a key, the key being disposed corresponding to the second sealing element; and
an upper cover assembled in the upper accommodating groove, a lower surface of the upper cover protruding downward to form a pressing portion, the pressing portion abutting against an upper surface of the second sealing element, the lower surface of the upper cover protruding downward to form an extending portion, the extending portion being disposed corresponding to the first through hole, the extending portion passing downward through the elastic element, the holding groove, the first through hole, a middle of the first sealing element and the second through hole from the upper accommodating groove.

2. The waterproof button assembly as claimed in claim 1, wherein the lower cover has a base portion, an upper surface of the base portion of the lower cover protrudes upward to form a convex portion, an upper surface of the convex portion abuts against the lower surface of the first sealing element, the second through hole penetrates through the base portion and a middle of the convex portion of the lower cover along the up-down direction.

3. The waterproof button assembly as claimed in claim 1, wherein the base portion is a U shape.

4. The waterproof button assembly as claimed in claim 1, wherein the first sealing element is an annular shape.

5. The waterproof button assembly as claimed in claim 1, wherein a portion of the lower surface of the body is recessed inward to form a first sealing slot around a periphery of a bottom mouth of the first through hole, the first sealing element is sealed in the first sealing slot.

6. The waterproof button assembly as claimed in claim 5, wherein the first sealing slot is an annular shape.

7. The waterproof button assembly as claimed in claim 1, further comprising a fixing element, the elastic element being mounted around the extending portion, the elastic element being accommodated in the upper accommodating groove, a middle of a bottom surface of the extending portion being recessed inward to form a fixing hole, the fixing element being fixed in the fixing hole, an outer edge of a free end of the fixing element protruding outward to form an abutting portion, the abutting portion of the fixing element abutting against a bottom of a peripheral wall of the second through hole.

8. The waterproof button assembly as claimed in claim 7, wherein the fixing element is a screw, and the abutting portion is a washer of the screw.

9. The waterproof button assembly as claimed in claim 7, wherein a bottom of the second through hole expands outward to form an expanding hole, a diameter of the expanding hole is larger than a diameter of the second through hole, the abutting portion is located in the expanding hole.

10. The waterproof button assembly as claimed in claim 1, wherein each of the first sealing element and the second sealing element is made of a silicone material.

11. The waterproof button assembly as claimed in claim 1, wherein the lower accommodating groove is a U shape, the lower cover is the U shape, the lower cover covers the lower accommodating groove to form the assembling space between the lower cover and the body, the circuit board is the U shape, the assembling space is the U shape.

12. A waterproof button assembly, comprising:
a body, several portions of an upper surface of the body being recessed downward to form a plurality of upper accommodating grooves, a lower surface of the body being recessed inward to form a lower accommodating groove, two sides of a bottom wall of each upper accommodating groove being recessed downward to form two holding grooves, a bottom wall of each holding groove defining a first through hole penetrating through the bottom wall of each holding groove along an up-down direction, each holding groove being positioned around a periphery of a top mouth of the first through hole of each holding groove, several portions of the lower surface of the body being recessed inward to form a plurality of first sealing slots, each first sealing slot being disposed around a periphery of a bottom mouth of the first through hole of one holding groove, a middle of the bottom wall of each upper accommodating groove being recessed downward to form a second sealing slot, the second sealing slot being located between the two holding grooves, the body having a plurality of openings penetrating through the body along the up-down direction, each opening penetrating through a bottom wall of one second sealing slot along the up-down direction, the opening being communicated between the upper accommodating groove and the lower accommodating groove;
a plurality of elastic elements mounted in the holding grooves of the body;
a plurality of first sealing elements sealed in the first sealing slots of the body;
a plurality of second sealing elements, each second sealing element being sealed in the one second sealing slot of the body, each second sealing element being assembled to a top of one opening;
a lower cover covering the lower accommodating groove to form an assembling space between the lower cover and the body, the lower cover defining a plurality of second through holes vertically penetrating through the lower cover, each second through hole being disposed corresponding to the first through hole of the one holding groove, each first sealing slot being disposed around one second through hole, an upper surface of the lower cover abutting against a lower surface of each first sealing element, the assembling space being sealed by each first sealing element and each second sealing element;
a circuit board assembled in the assembling space, the circuit board being equipped with a plurality of keys, each key being disposed corresponding to one second sealing element; and
a plurality of upper covers assembled in the plurality of the upper accommodating grooves, a middle of a lower surface of each upper cover protruding downward to form a pressing portion, the pressing portion of each upper cover abutting against an upper surface of the one second sealing element, two sides of the lower surface of each upper cover protruding downward to form two extending portions, each extending portion being disposed corresponding to the first through hole of the one holding groove, each extending portion passing downward through one elastic element, the one holding groove, the first through hole of the one holding groove, one first sealing slot, a middle of one first sealing element and the one second through hole from one upper accommodating groove.

13. The waterproof button assembly as claimed in claim 12, wherein the lower cover has a base portion, several portions of an upper surface of the base portion protrude upward to form a plurality of convex portions, an upper surface of each convex portion abutting against the lower surface of the one first sealing element, the lower cover defines the plurality of the second through holes vertically penetrating through the base portion and middles of the plurality of the convex portions.

14. The waterproof button assembly as claimed in claim 12, wherein each first sealing slot is the annular shape, and each first sealing element is the annular shape.

15. The waterproof button assembly as claimed in claim 12, wherein the waterproof button assembly includes a plurality of fixing elements, each elastic element is mounted around one extending portion, the plurality of the elastic elements are accommodated in the plurality of the upper accommodating grooves, a middle of a bottom surface of each extending portion is recessed inward to form a fixing hole, each fixing element is fixed in the fixing hole of the one extending portion, an outer edge of a free end of each fixing element protrudes outward to form an abutting portion, the abutting portion of each fixing element abuts against a bottom of a peripheral wall of the one second through hole, the lower cover is fastened to the body by the plurality of the fixing elements, and then the assembling space becomes a sealed status.

16. The waterproof button assembly as claimed in claim 15, wherein each fixing element is a screw, and the abutting portion of each fixing element is a washer of the screw.

17. The waterproof button assembly as claimed in claim 15, wherein a bottom of each second through hole expands outward to form an expanding hole, a diameter of the expanding hole is larger than a diameter of each second through hole, the abutting portion of each fixing element is located in the expanding hole.

18. The waterproof button assembly as claimed in claim 12, wherein each first sealing element and each second sealing element are made of silicone materials.

19. A waterproof button assembly, comprising:
a body, several portions of an upper surface of the body being recessed downward to form a plurality of upper accommodating grooves, a lower surface of the body being recessed inward to form a lower accommodating groove, two sides of a bottom wall of each upper accommodating groove being recessed downward to form two holding grooves, a bottom wall of each holding groove defining a first through hole penetrating through the bottom wall of each holding groove along an up-down direction, each holding groove being positioned around a periphery of a top mouth of the first through hole of each holding groove, several portions of the lower surface of the body being recessed inward to form a plurality of first sealing slots, each first sealing slot being disposed around a periphery of a bottom mouth of the first through hole of one holding groove, a middle of the bottom wall of each upper accommodating groove being recessed downward to form a second sealing slot, the second sealing slot of each upper accommodating groove being located between the two holding grooves of each upper accommodating groove, the body having a plurality of openings, each opening penetrating through a bottom wall of the second sealing slot of one upper accommodating groove along the up-down direction, each opening being communicated between the one upper accommodating groove and the lower accommodating groove;
a plurality of elastic elements mounted in the holding grooves of the body;
a plurality of first sealing elements sealed in the first sealing slots of the body;
a plurality of second sealing elements, each second sealing element sealing the second sealing slot of the one upper accommodating groove of the body, each second sealing element being assembled to a top of one opening;
a lower cover covering the lower accommodating groove to form an assembling space between the lower cover and the body, the lower cover having a base portion, several portions of an upper surface of the base portion protruding upward to form a plurality of convex portions, the lower cover defining a plurality of second through holes vertically penetrating through the base portion and middles of the plurality of the convex portions, each second through hole being disposed corresponding to the first through hole of the one holding groove, each first sealing slot being disposed around one second through hole, an upper surface of each convex portion abutting against a lower surface of one first sealing element, each first sealing element sealing between one first sealing slot and one convex portion, the assembling space being sealed by each first sealing element and each second sealing element;
a circuit board assembled in the assembling space, the circuit board being equipped with a plurality of keys, each key being disposed corresponding to one second sealing element;
a plurality of upper covers assembled in the plurality of the upper accommodating grooves, a middle of a lower surface of each upper cover protruding downward to form a pressing portion, the pressing portion of each upper cover abutting against an upper surface of the one second sealing element, two sides of the lower surface of each upper cover protruding downward to form two extending portions, each extending portion being disposed corresponding to the first through hole of the one holding groove, each extending portion passing downward through one elastic element, the one holding groove, the first through hole of the one holding groove, the one first sealing slot, a middle of the one first sealing element and the one second through hole from one upper accommodating groove; and
a plurality of fixing elements connected to bottoms of the extending portions of the plurality of the upper covers, a middle of a bottom surface of each extending portion being recessed inward to form a fixing hole, each fixing element being fixed in the fixing hole of one extending portion, an outer edge of a free end of each fixing element protruding outward to form an abutting portion, the abutting portion of each fixing element abutting against a bottom of a peripheral wall of the one second through hole.

20. The waterproof button assembly as claimed in claim 19, wherein each convex portion is a cylinder shape.
